(19) United States
(12) Patent Application Publication
(10) Pub. No.: US 2023/0402811 A1
(43) Pub. Date: Dec. 14, 2023

(54) SAMPLING PROCESS LIGHT IN A FIBER LASER SYSTEM

(71) Applicant: NIGHT, INC., Vancouver, WA (US)

(72) Inventors: C. Geoffrey Fanning, Vancouver, WA (US); Jay SMALL, Vancouver, WA (US); Kevin Michael CARBONE, Vancouver, WA (US); Sean R. GALLIVAN, Vancouver, WA (US)

(73) Assignee: NIGHT, INC., Vancouver, WA (US)

(21) Appl. No.: 18/035,503

(22) PCT Filed: Mar. 12, 2021
(86) PCT No.: PCT/US2021/022123

§ 371 Date: May 4, 2023

Related U.S. Application Data
(60) Provisional application No. 63/118,360, filed on Nov. 25, 2020.

(51) Int. Cl. H01S 3/094; H01S 3/067

(52) U.S. Cl. CPC H01S 3/094007; H01S 3/067

(57) ABSTRACT

Some embodiments may include a fiber laser having an input end to receive source light from a light source and an output end including: a feeding optic fiber including a cladding layer and an interior surrounded by the cladding layer, wherein the interior emits a beam at an end of the feeding optic and the cladding layer receives process light at the end of the feeding optic, the process light generated by processing of a workpiece by the beam; and a notch or other discontinuity in an outer surface of a side of the cladding layer, the surface discontinuity to release a portion of the process light, the apparatus further comprising: a collection optic fiber having a first end to capture a sample of the released process light and a second end to provide the captured sample to a sensor. Other embodiments may be disclosed and/or claimed.

### PRIORITY

The present application is a National Phase entry under 35 U.S.C. § 371 of International Application No. PCT/US2021/022123, filed on Mar. 12, 2021, which claims priority to U.S. Provisional Application No. 63/118,360 filed on Nov. 25, 2020, entitled HIGHLY EFFICIENT CLAD-LIGHT SENSOR, the entire contents of these applications are incorporated herein by reference in their entirety.

### TECHNICAL FIELD

The present disclosure relates to fiber lasers.

### BACKGROUND

Fiber lasers are widely used in industrial processes (e.g., cutting, welding, cladding, heat treatment, etc.) In some fiber lasers, the optical gain medium includes one or more active optical fibers with cores doped with rare-earth element(s). The rare-earth element(s) may be optically excited (“pumped”) with light from one or more semiconductor laser sources. There is great demand for high power and high efficiency diode lasers, the former for power scaling and price reduction (measured in $/Watt) and the latter for reduced energy consumption and extended lifetime.

### BRIEF DRAWINGS DESCRIPTION

The accompanying drawings, wherein like reference numerals represent like elements, are incorporated in and constitute a part of this specification and, together with the description, explain the advantages and principles of the presently disclosed technology.

FIG. 1 illustrates a schematic diagram of a fiber laser system to sample process light, according to various embodiments.

FIG. 2 illustrates a top view of system to sample process light, according to various embodiments.

FIG. 3 illustrates a detailed view of collection optic fiber of FIG. 2.

FIG. 4 illustrates a side view of a notched feeding optic fiber, according to various embodiments.

FIG. 5 illustrates an isometric view of the surface discontinuity of FIG. 4.

FIG. 6 illustrates a top view of the surface discontinuity of FIG. 4.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items. The systems, apparatus, and methods described herein should not be construed as limiting in any way. Instead, the present disclosure is directed toward all novel and non-obvious features and aspects of the various disclosed embodiments, alone and in various combinations and sub-combinations with one another. The term “or” refers to “and/or,” not “exclusive or” (unless specifically indicated).

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation. Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus.

Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

A fiber laser system may include a feeding optic fiber to output a beam to process a workpiece, and a cutting head that positions optics between an output of the feeding optic fiber and the workpiece. In some fiber laser system, a sensing device is provided on the cutting head to measure one or more characteristics of process light from the workpiece (process light may include light resulting from processing the workpiece). These known sensing devices may add bulk to the cutting head, which may impede operation of the fiber laser (as just one example, the added bulk may limit some orientations/positions of the process head relative to the workpiece and/or complicate moving the process head).

Other known arrangements, used in fiber laser architectures that combine the output signals of multiple individual lasers into a larger system output fiber, may include a sensing device coupled to the combiner. One of the combiner inputs may not be populated (this combiner input may instead be used to collect the process light and transport it out of the laser system to provide sense light to the user). Although these arrangements are not located on the cutting head, this approach may require the use of a combiner, which may not be included in some fiber lasers.

The known combiner collection systems may also collect process light from the cavity volume in the vicinity of a clad light stripper. While this may provide sufficient laser light at certain wavelength(s), this collection method may have a difficult time collecting sufficient light at all the wavelengths of potential interest. For at least these reasons, fiber laser operators/users would like the fiber laser manufacturers to offer alternative arrangements for determining characteristics of the process light.

Some embodiments described herein include a process light collection system to collect process light in a fiber laser system. The process light collection system may include a discontinuity (e.g., a notch) in an outermost cladding layer of a feeding optic fiber of the fiber laser, and a collection optic fiber having a first end to capture a sample of process light released from the discontinuity and a second end to output the captured process light for analysis. The fiber laser operator/user may input the light from the second end of the collection optic fiber into any known sensor to determine one or more characteristics of the process light. In some embodiments, this light collection system may be used in addition to, or instead of, light sensing devices attached to a cutting head of the fiber laser.

In addition to reflected and scattered laser light from the workpiece, the collected process light may include light generated by the processing of the work piece in the short wavelength band between 400 and 850 nm as well as light in the long wavelength band between 1400 and 1800 nm. In addition, in various embodiments, the transmission between the high-power output of the fiber laser and the output of the collection optic fiber may not distort the shape of the process light spectrum in the short and long wavelength bands. Within any band the fraction of optical power originating solely from within the fiber laser may be small compared to the optical power collected from the work piece under typical processing conditions of interest.

Process optics may shape and project the beam output from the feeding optic fiber onto the work piece undergoing processing. In contrast to systems that include sensing devices only on the cutting head, process light from the workpiece may travel through the same process optics and enter the feeding optic fiber (the process light may enter a glass core and a glass cladding of the feeding optic fiber).

A shape of the notch may be arranged to maximize diversion of cladding light incident on the notch to a location of a face of the collection optic fiber. The collection optic fiber may be aligned to the feeding optic fiber at an angle chosen to direct the diverted cladding light into the core of the feeding optic fiber, to maximize the transfer of backward-traveling light from the notch into the collection optic fiber.

In various embodiments, the end few millimeters (or some other length) of the sense-collection fiber may be stripped of protective buffer material to enable a consistent end face preparation of the collection optic fiber, and to provide a clean and mechanically reliable surface for attaching to a mounting surface at the optimal alignment point relative to the feeding optic fiber.

Process light may be collected by both the core and the cladding of the collection fiber optic fiber. In some cases the power in the collection optic fiber cladding could contribute excessive heat to the attachment point and/or to the buffer material protecting the glass fiber. To avoid such heat (which could cause misalignment or degradation of the fiber attachment), an attach material with low optical index of refraction relative to the fiber optic cladding glass may be employed to allow the cladding to transmit most of the power further down the collection optic fiber. Furthermore, the collection optic fiber may be a double clad fiber, meaning light collected in the core and most of the light collected in the cladding of the collection optic fiber may be transmitted by the collection optic fiber. Transmitting the power in the fiber cladding avoids dissipating energy in the thermally delicate fiber buffer were it made of matched or high refractive index material as in the case of a single clad fiber.

In the case of a double clad fiber with significant clad coupled optical power there is risk the clad coupled power could damage downstream devices. To reduce such risk the double clad fiber may be spliced to a single clad fiber incapable of transmitting the clad light and the clad light may be dissipated in a matched or high optical index potting material heat sunk at the location of the fiber splice. The second end of the collection optic fiber may be the single clad fiber. The remaining core light is then available for presentation to the operator/user from the single-clad optical-sense fiber which may be terminated as a cut fiber end or with the optical connector of the user's choice.

To reduce light collection from within the feeding optic fiber, typical clad light stripping methods may be employed in the feeding optic fiber or some other part of the fiber laser. These clad light strippers may be located upstream from the notch e.g., between the notch and a fiber laser source.

To reduce sensitivity of the collection system to temperature change, the attachment points of the feeding optic fiber may be arranged relative to the notch so coefficient of thermal expansion (CTE) differences between the fiber and the sense housing materials do not result in significant changes in positioning between the notch and the collection optic fiber. Specifically, the attach points may be located close to either side of the notch and provide a straightened section of the feeding optic fiber around the notch (so there is reduced arc near the notch in the feeding optic fiber to prevent position changes between the feeding optic fiber and the tip of the sense-collection fiber under temperature changes). To improve ruggedness, the collection optical fiber may have a second attachment point over the fiber buffer to isolate the critically aligned attachment point from stress applied external to the housing.

The optical signal from the collection optic fiber may be transmitted to an optical-to-electrical conversion device such as a photodiode to obtain information about the process being executed by the user with the fiber laser. That information may be obtained by monitoring the amplitude of the signal as a function of process time. The optical signal may be spectrally resolved into more than one spectral channel, for example a short wavelength channel potentially due to plasma generated in the laser material processing, a channel at the wavelength of the laser related to reflection and scattering from the laser material interaction, and a long wavelength channel potentially related to the temperature of the material undergoing laser processing. Each channel may then be individually converted from an optical to an electrical signal for ease of signal processing. More than three channels are possible. Simultaneous monitoring of the plethora of electrical signals representing each of spectral channels may allow additional information to be extracted from this signals by examining their correlation. The electrical signals may be filtered, such as by low pass, band-pass or high-pass filters to reduce noise interfering with signal processing, and/or to more easily identify transitions in the signal indicating process transitions.

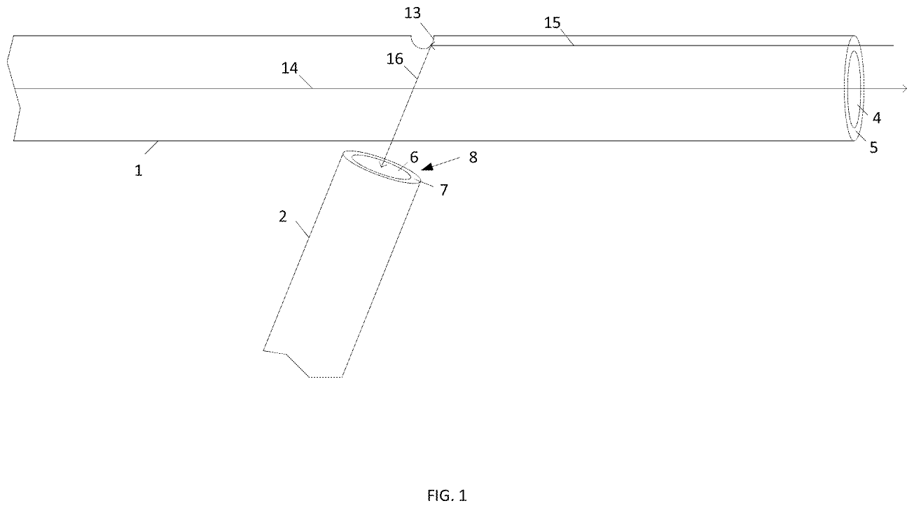

FIG. 1 illustrates a schematic diagram of a fiber laser system to sample process light, according to various embodiments. The fiber laser system includes a fiber laser having an input end (not shown) to receive source light from a light source and an output end to deliver a beam to a workpiece. The output end includes a feeding optic fiber 1 including a cladding layer 5 and an interior 4 surrounded by the cladding layer 5 (e.g., one or more layers including a core to output a beam of the laser light 14). A discontinuity, such as a notch 13, is provided in the cladding layer 5 to release a portion of process light 15 that is received in the cladding layer 5.

The system also includes a collection optic fiber 2 having a first end with an end face 8 to receive the release process light 16 and a second end (not shown) to provide the captured sample to a sensor. The collection optic fiber 2 may include a core 6 and one or more cladding layers 7 around the core. The one or more cladding layers 7 may be similar to any collection optic fiber cladding layers described herein.

The notch 13 and the collection optic fiber 2 may be held in position relative to each other using any retention system now known or later developed. In various embodiments, the retention system may include a mounting surface and one or more adhesives for affixing one or both of fibers 1 and 2 to the mounting surface. The mounting surface may be made of metal or any other heat conductive material, and the mounting surface may be thermally coupled to any known heat sink (not shown), such as a cold plate. In other examples, it may be possible and practical to retain one or both of the fibers 1 and 2 in place using a supporting arm, a suspension system, or some other retention system, and these may be used in combination with, or instead of, a mounting surface.

In this example, the notch 13 and the collection optic fiber 2 may be located on opposite sides of the feeding optic fiber 1. In other embodiments, it may be possible to locate an outer surface discontinuity and the collection optic fiber 2 on a same side of the feeding optical fiber 1.

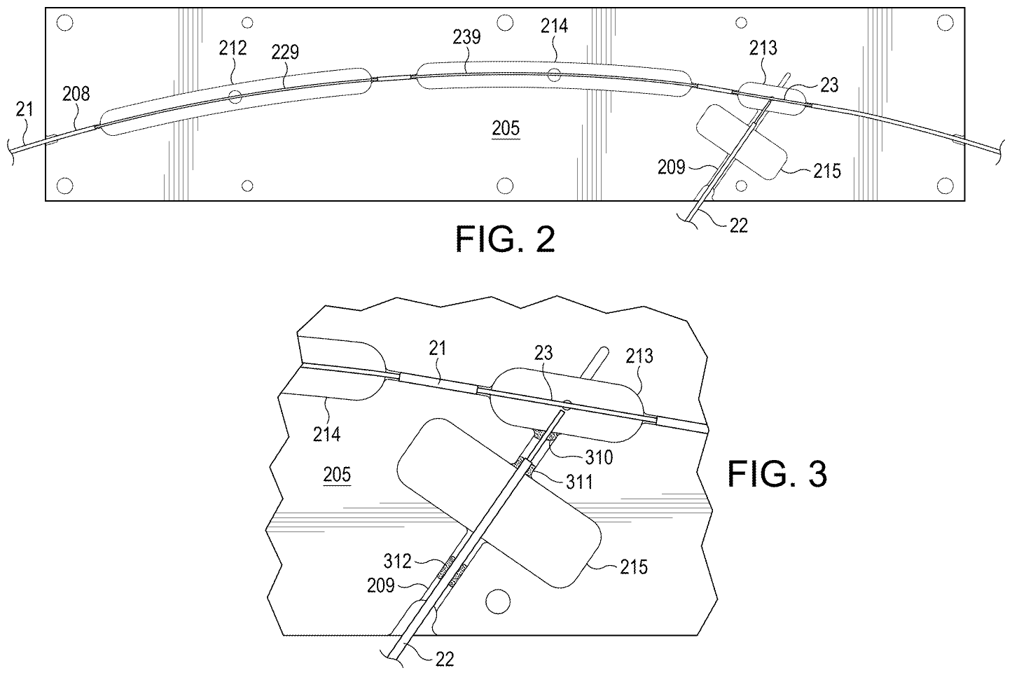

FIG. 2 illustrates a top view of system to sample process light, according to various embodiments. This system includes a feeding optic fiber 21 and a collection optic fiber 22, which may be similar, respectively, to any feeding optic fiber and collection optic fiber described herein. This system includes a thermally conductive mounting surface 205, which may transfer heat from the feeding optic fiber 21 to a heat sink (not shown—a back of the mounting surface 205, opposite the illustrated surface, may be fastened to a cold plate in one example).

The mounting surface 205 may define a continuous groove 208 with one or more channels (such as channels 212, 213, and 214), and the optical feeding fiber 21 may be located in the continuous groove 208. In this example, the groove 208 has an arc shape, but in other examples the groove 208 may have some other shape. In another embodiment, a continuous groove may have arc segments and straight segments, and the channel 213 may correspond to one of the straightened segments. The mounting surface 205 may also define an additional groove 209 for the optical feeding fiber 21, and in this embodiment the additional groove 209 has straight segments.

The mounting surface 205 may define a channel 215 over which a section of the collection optic fiber 22 is suspended. The channel 215 may form a gap between the suspended section and the mounting surface 205.

Referring now to FIG. 3, individual sections of the collection optic fiber 22 on either side of the channel 215 may be adhesively coupled to the mounting surface 205. In the present embodiment, different adhesives 311 and 312 are used on the different individual sections. A first section that is closer to the feeding optical fiber 21 may be adhered using a first adhesive 311, such as MY-132, or some other adhesive with low optical index of refraction relative to the fiber optic cladding glass. A second section on the other side of the channel 215 may be adhered using a second different adhesive, such as NOA-61, or some other strain-relieving adhesive. The second adhesive may be arranged to hold the feeding optical fiber 21 in place if the other end of the collection optic fiber 22 is subjected to movement.

As illustrated, the collection optic fiber 22 may be stripped of its buffer section near the notch. A potting material may affix the stripped section to the mounting surface 205. The first adhesive 311 may be applied to the unstripped part of the collection optic fiber 22. The potting material 310 and the first adhesive 311 may be arranged to minimize heating as compared to the second section with the strain-relieving adhesive 312, which may minimize movement of the face of the collection optic fiber 22 relative to the feeding optic fiber 21 due to thermal expansion.

A width of the channel 215, or any other channel described herein, may be sized based on a pincer or other tool (not shown) used to precisely position the collection optic fiber 22 relative to the notch 23. The collection optic fiber 22 may be precisely position using the channel 215 (or some other part of the groove 209) to provide a gap between the face of the collection optic fiber 22 and an outer surface of the side of the cladding layer of the feeding optic fiber 21. The gap may be sized to prevent contact between the cladding layer and the collection optic fiber 22 at maximum operating temperature (the released process light may traverse the gap to couple into the face of the collection optic fiber 22). The length of the channel 215 may be based on the size of the tool and/or a desired distanced between the individually adhered sections.

Referring again to FIG. 2, the mounting surface 205 may define a channel 213 over which a section of the feeding optic fiber 21 is suspended. The suspended section may be stripped of its buffer section, as illustrated, to expose the outer surface of the cladding layer that defines the notch 23. The channel 213 may form a gap between the suspended section and the mounting surface 205. In various embodiments, the channel 213 and/or a portion of the groove 208 on either side of the channel 213 may be arranged to provide a straightened section of the feeding optic fiber 21 (where the notch 23 is located in the straightened section). This may reduce relative movement between the notch 23 and the face of the collection optical fiber 21 due to thermal expansion.

In this embodiment, CLSs (clad light strippers) 229 and 239 are provided upstream of the notch 23, in the channels 212 and 214, respectively. Each of the upstream CLSs 229 and 239 may strip some source light coupled in the cladding to prevent this source light from being released from the notch 23, which may prevent that stripped source light from entering a face of the collection optical fiber 22. The face of the collection optical fiber 22 may also be arranged in a plane that is not parallel to a plane bisecting the feeding optical fiber 21 in the lengthwise direction, so that forward-traveling light released from the notch 23 does not couple into the face (in this way the process light is isolated from the forward-traveling light so that most of the collected light is process light and not forward-traveling light). The face may be angled so that an intersection of the planes is upstream from the notch 23 (so that the face receives more process light than forward-traveling light).

Downstream from the notch 23, there may be no surface discontinuities (the surface may be smooth), which guides the process light within the cladding layer to the notch 23. The upstream CLS may be arranged to strip out any remaining process light that is not stripped by the notch 23.

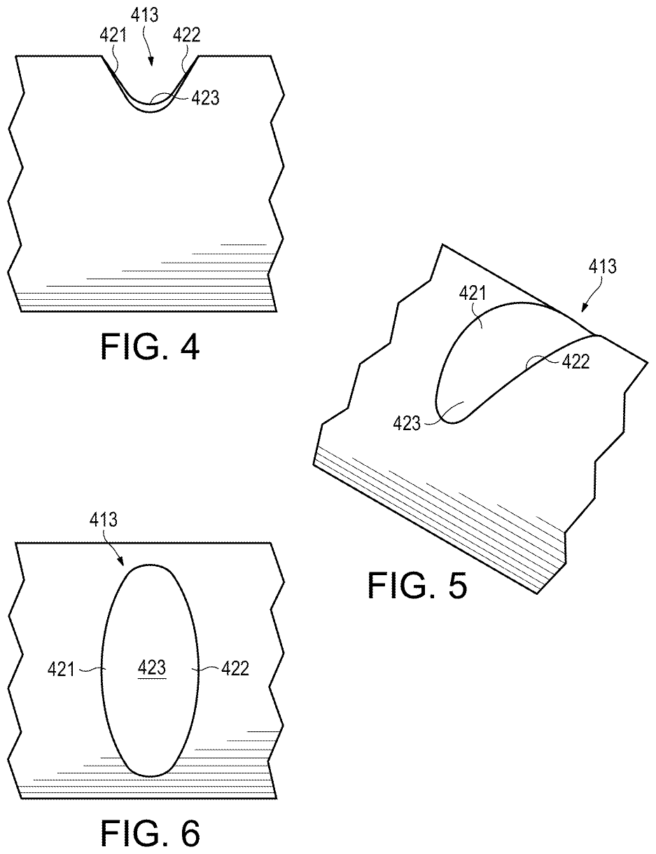

FIG. 4 illustrates a side view of a notched feeding optic fiber, according to various embodiments. The surface discontinuity 413 may be formed by laser machining, to form smooth sidewalls 421 and 422. In this example, the surface discontinuity 413 is symmetric (with sidewalls 421 and 422 having identical slopes), but in other examples a surface discontinuity may be asymmetric (with differently sloped sidewalls). In this example, the surface discontinuity 413 has a rounded bottom 423 based on the laser machining, but in other examples a surface discontinuity may have a flat bottom or may not have any bottom (e.g., V-shaped with a vertex formed by the sidewalls). In this example, the sidewalls 421 and 422 have linear slopes, but in other examples the sidewalls may have non-linear slopes or may be faceted. Any surface discontinuity may have a surface arranged to release the process light by scattering the process light, deflecting the process light using specular deflection, or the like, or combinations thereof. FIG. 5 illustrates an isometric view of the surface discontinuity 413, and FIG. 6 illustrates a top view of the surface discontinuity 413.

In view of the many possible embodiments to which the principles of the disclosed technology may be applied, it should be recognized that the illustrated embodiments are only preferred examples and should not be taken as limiting the scope of the disclosure. We claim as our invention all that comes within the scope and spirit of the appended claims.

1. An apparatus, comprising:
a fiber laser having an input end to receive source light from a light source and an output end to deliver a beam to a workpiece, wherein the output end includes:
a feeding optic fiber including a cladding layer and an interior surrounded by the cladding layer, wherein the interior emits the beam at an end of the feeding optic and the cladding layer receives process light at the end of the feeding optic, the process light generated by processing of the workpiece by the beam; and
a discontinuity in an outer surface of a side of the cladding layer, the outer surface discontinuity to release a portion of the process light, the apparatus further comprising:
a collection optic fiber having a first end to capture a sample of the released process light and a second end to provide the captured sample to a sensor.

2. The apparatus of claim 1, further comprising:
a mounting surface, wherein part of the fiber laser is affixed to the mounting surface or part of the collection optic fiber is affixed to the mounting surface.

3. The apparatus of claim 2, further comprising a gap between the first end of the collection optic fiber and the outer surface of the side of the cladding layer.

4. The apparatus of claim 3, wherein the outer surface discontinuity is defined by a first side of the outer surface and the gap is between a second opposite side of the outer surface and the collection optic fiber.

5. The apparatus of claim 3, wherein the gap is sized to prevent contact between the cladding layer and the collection optic fiber at maximum operating temperature, wherein the captured sample of the released process light traverses the gap.

6. The apparatus of claim 2, wherein the part of the fiber laser includes one or more curved sections and a straightened section, wherein the outer surface discontinuity is located in the straightened section.

7. The apparatus of claim 3, wherein the part of the fiber laser is adhered to the mounting surface on both sides of a channel defined by the mounting surface, wherein the channel is located under the outer surface discontinuity and a section of the fiber laser above the channel is suspended over the channel, and wherein the suspended section has its buffer stripped and has no adhesive thereon.

8. The apparatus of claim 7, wherein the channel comprises a first channel defined by the mounting surface, wherein the part of the collection optic fiber is adhered to the mounting surface on both sides of a second channel defined by the mounting surface.

9. The apparatus of claim 8, wherein individual sections of the collection optic fiber are adhered to the mounting surface using different adhesive materials.

10. The apparatus of claim 9, wherein the individual sections include a first section that is closer to the fiber laser than a second section of the individual sections, wherein the adhesive material on the first section comprises a first adhesive and wherein the adhesive substance on the second section comprises a second strain-relieving adhesive.

11. The apparatus of claim 2, wherein the mounting surface comprises a metal surface.

12. The apparatus of claim 2, wherein the metal surface comprises part of a cold plate or is thermally coupled to the cold plate.

13. The apparatus of claim 1, further comprising a clad light stripper proximate to the outer surface discontinuity, the clad light stripper arranged to process light traveling towards the work piece in the cladding layer to guide said light away from the outer surface discontinuity.

14. The apparatus of claim 11, wherein an end face disposed on the end of the collection optic fiber lies in a plane that intersects a plane bisecting the fiber laser at the outer surface discontinuity location.

15. The apparatus of claim 1, wherein the outer surface of the side of the cladding layer from the outer surface discontinuity to the end of the feeding optic fiber is smooth, the smooth outer surface to guide the process light inside the cladding layer towards the outer surface discontinuity.

16. The apparatus of claim 1, wherein the process light includes back-reflected light from the workpiece and additional light generated by the processing.

17. The apparatus of claim 1, wherein the outer surface discontinuity includes sloped sidewalls.

18. The apparatus of claim 1, wherein the sloped sidewalls have different slopes.

19. The apparatus of claim 1, wherein the outer surface discontinuity is arranged to scatter the process light.

20. The apparatus of claim 1, wherein the outer surface discontinuity is arranged to deflect the process light using specular reflection.
